(19) United States
(12) Patent Application Publication
(10) Pub. No.: US 2006/0012342 A1
(43) Pub. Date: Jan. 19, 2006

(54) Self-heating battery that automatically adjusts its heat setting

(75) Inventor: Robert Kamenoff, Port Orange, FL (US)

Correspondence Address: RICHARD K. WARTHER;Allen, Dyer, Doppelt, Milbrath & Gilchrist, P.A., P.O. Box 3791, Orlando, FL, 32802, US

(73) Assignee: MATHEWS ASSOCIATES, INC., Sanford, FL (US)

(21) Appl. No.: 11/178,985

(22) Filed: Jul. 11, 2005

Related U.S. Application Data
(63) Continuation-in-part of application No. 10/694,635, filed on Oct. 27, 2003.
Application No. 10/694,635 is a continuation-in-part of application No. 10/452,738, filed on Jun. 2, 2003, now Pat. No. 6,900,615.
(60) Provisional application No. 60/396,292, filed on Jul. 17, 2002.

(51) Int. Cl. H02J 7/04

(52) U.S. Cl. 320/153

(57) ABSTRACT

A self-heating battery includes a battery, heating element operatively connected to the battery for heating the battery and a temperature sensor for determining the temperature of the battery. A switch is operatively connected to the heating element and temperature sensor and responsive to the temperature sensor for switching on the heating element and raising the temperature of the battery to allow the battery to deliver its rated capacity when a sensed temperature of the battery is below a temperature where available battery capacity is limited. A load sensing circuit is operative with the switch for sensing load demand and activating low or high heat modes.

### RELATED APPLICATION

This is a continuation-in-part patent application based upon prior filed copending utility application Ser. No. 10/694,635, filed Oct. 27, 2003, which is a continuation-in-part application of Ser. No. 10/452,738, filed Jun. 2, 2003, now U.S. Pat. No. 6,900,615, which is based on prior filed provisional application Ser. No. 60/396,292 filed Jul. 17, 2002, the disclosures which are hereby incorporated by reference in their entirety.

### FIELD OF THE INVENTION

The present invention relates to batteries, and more particularly, the present invention relates to batteries with self-heating circuits.

### BACKGROUND OF THE INVENTION

U.S. Pat. No. 6,900,615 addresses the situation where federal, state and local agencies require many types of batteries, including primary or rechargeable batteries, for example lithium-ion batteries as one example only, to be discharged completely prior to discarding the battery. Also, any discharging of such batteries must occur without breaking seals and ensuring reliability.

These reliability and sealing problems for these batteries can be overcome by the incorporation of a light sensing circuit that contains no moving parts and is connected to a battery discharge circuit such that the battery discharge circuit is actuated after exposing to light the light sensing circuit. Further details are found in the incorporated by reference U.S. Pat. No. 6,900,615.

There are also different functions associated with battery discharge circuits. One of these functions is a heating circuit, which is advantageous at lower temperatures. The internal battery resistance, however, can increase significantly at lower temperatures. In most battery applications, any equipment being powered by the cell or battery has a minimum operating voltage, commonly called the “cut-off voltage.” A reduced terminal voltage at lower temperatures causes the powered equipment to reach its cut-off voltage prematurely, while the cell or battery has much remaining stored capacity. This phenomenon becomes dominant at the lower 10° C. or so of the cell or battery specified operating temperature range. In some cases at the minimum, specified operating temperature, it is possible to obtain only 10% or 20% of the total capacity from the cell or battery.

The above-identified and incorporated by reference U.S. patent application Ser. No. 10/694,635 discloses a self-heating battery for delivering a rated capacity when the battery is below a temperature where available battery capacity is limited. The self-heating battery includes a battery and a heating element operatively connected to the battery and powered therefrom for heating the battery. A temperature sensor determines the temperature of the battery. A switch is operatively connected to the heating element and temperature sensor and responsive to the temperature sensor for switching on the heating element and raising the temperature of the battery to allow the battery to deliver its rated capacity when a sensed temperature of the battery is below a temperature where available battery capacity is limited. Although some provision is made for delivering its rated capacity when a sensed temperature of the battery is below a temperature where available battery capacity is limited, the amount of heat or the operating temperature required to optimize battery performance is dependent upon end-use application for the battery, specifically the peak power load demands placed on a battery.

### SUMMARY OF THE INVENTION

It is therefore an object of the present invention to optimize battery heating for different power demands without requiring different batteries for different applications.

In accordance with one aspect, a self-heating battery includes a battery and a heating element operatively connected to the battery for heating the battery. A temperature sensor determines the temperature of the battery. A switch is operatively connected to the heating element and temperature sensor and responsive to the temperature sensor for switching on the heating element and raising the temperature of the battery to allow the battery to deliver its rated capacity when the temperature of the battery is below a temperature where available battery capacity is limited. A load sensing circuit is operative with the switch for sensing load demand and activating low or high heat modes based on the load demand.

In accordance with one aspect, the load sensing circuit can be formed as a load sensing switch operative for activating battery heating based on sensed loads. The load sensing switch could be formed as a transistor. The load sensing circuit can also include a timer circuit such that after a predetermined time period, a low heat mode is activated after the battery initially powers in the high heat mode. The timer circuit can be formed as a long-term timer or short-term timer. The timer circuit could also be operative such that after a predetermined time, if a high powered load or pulse is not sensed, the low heat mode is activated.

In another aspect, the load current sensing circuit includes a load sensing device. A comparator has inputs operatively connected to the load sensing device and an output operatively connected to the load sensing switch for determining low and high power loads or pulses and controlling the load sensing switch. Low and high current load sensing switches have respective low and high current comparators connected thereto for sensing low and high current conditions and activating low or high heat modes.

A battery discharge circuit is operative with the battery such that when actuated, discharges the battery. The battery discharge circuit can be formed as a light sensing circuit operatively connected to the battery discharge circuit that actuates the battery discharge circuit after exposing to light the light sensing circuit. The heating element can also be powered from the battery. A housing can enclose the battery, heating element, temperature sensor and load sensing circuit.

In another aspect, the load sensing circuit operative with the switch is formed as a low current load sensing switch and high current load sensing switch operative with a switch connected to the heating element. A low current comparator is operatively connected to the low current load sensing switch, and a high current comparator is operatively connected to the high current load sensing switch. Both comparators are connected to a load current sensor for determining low and high power loads. A timer circuit is operative with the low and high current load sensing switches and comparators such that after a predetermined time period, a low or high heat mode is activated based on sensed loads.

### BRIEF DESCRIPTION OF THE DRAWINGS

Other objects, features and advantages of the present invention will become apparent from the detailed description of the invention, which follows when considered in light of the accompanying drawings in which:

FIG. 1 is a fragmentary, sectional view of a battery and showing basic components for discharging a battery, including a photocell as a light sensing circuit, an opaque pull tab, a transparent lense within a “window” opening of the battery casing, a circuit card that mounts components and includes a break-off tab, and the battery cells, such as lithium-ion cells.

FIG. 2 is a high level block diagram showing basic components used in an apparatus for discharging a battery.

FIG. 3 is a schematic circuit diagram of a battery discharge circuit and light sensing circuit.

FIG. 4 is a schematic circuit diagram of one example of a battery heater circuit, with automatic heat adjustment, in accordance with one non-limiting example of the invention.

FIGS. 5 and 6 are two different schematic circuit diagrams of examples of a charge protection circuit using a field effect transistor.

FIG. 7 is a schematic circuit diagram of a flying cell circuit using an extra series, tier of cells that are switched into service when the battery voltage falls to near the minimum cut-off voltage, and are switched out of service when the battery voltage rises to near the open circuit voltage.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

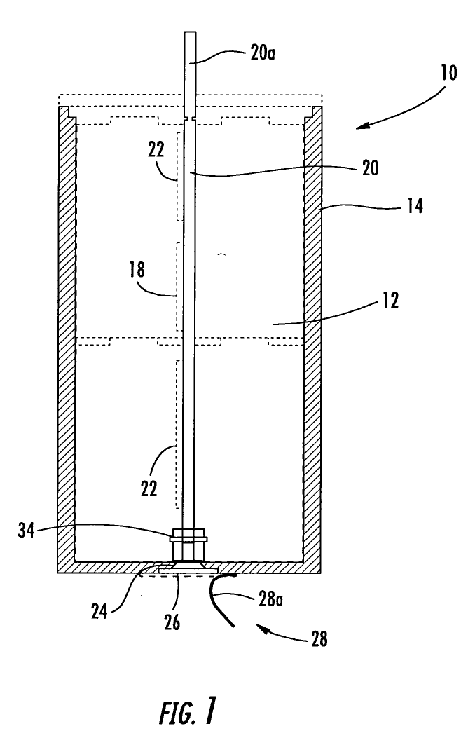

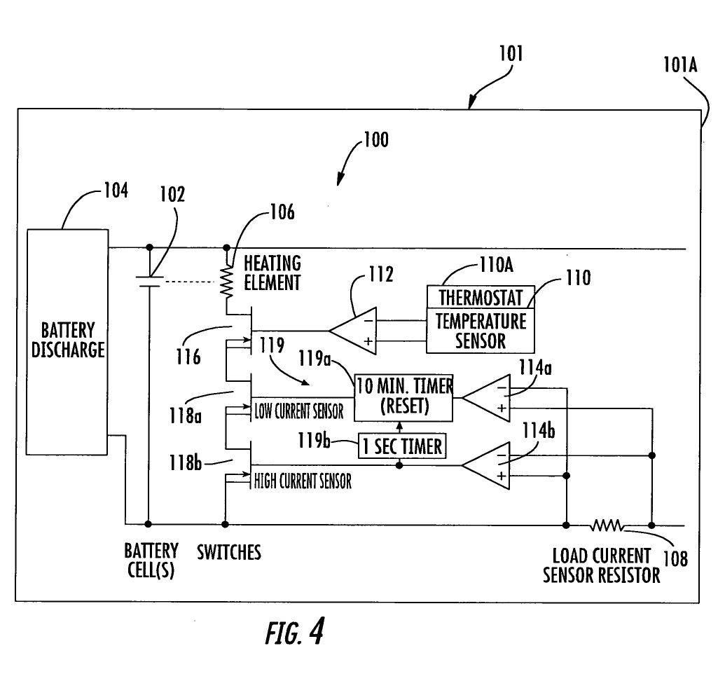

For purposes of description and background, the battery discharge circuit disclosed in the '738 application will be set forth relative to FIGS. 1-3. After describing in detail a battery discharge circuit relative to FIGS. 1-3, a description of other circuits that could operate alone or in conjunction with the battery discharge circuit will be set forth in detail. An example of a battery heater circuit with automatic heat adjustment, in accordance with one non-limiting example of the present invention is shown in FIG. 4.

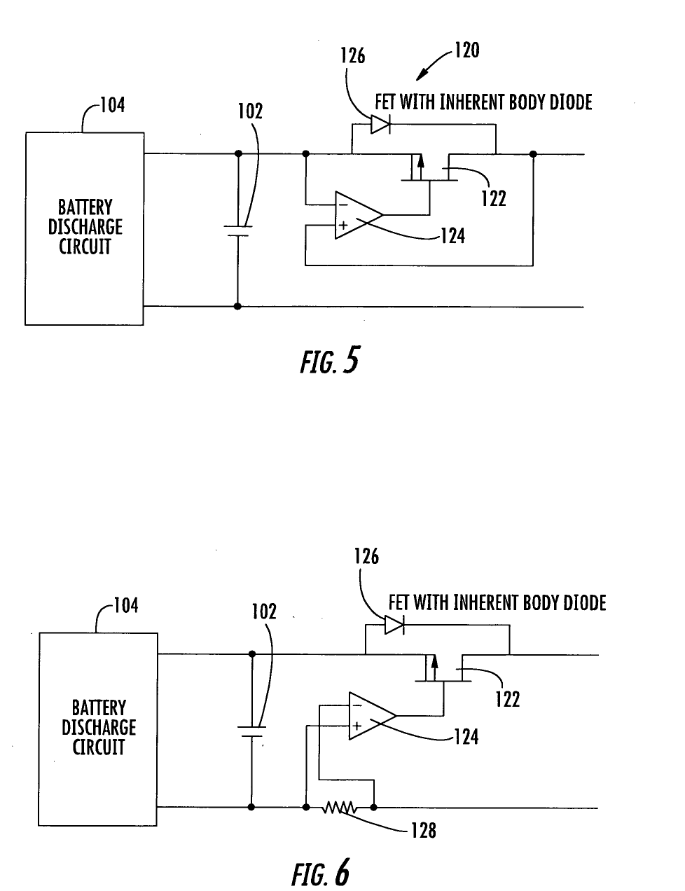

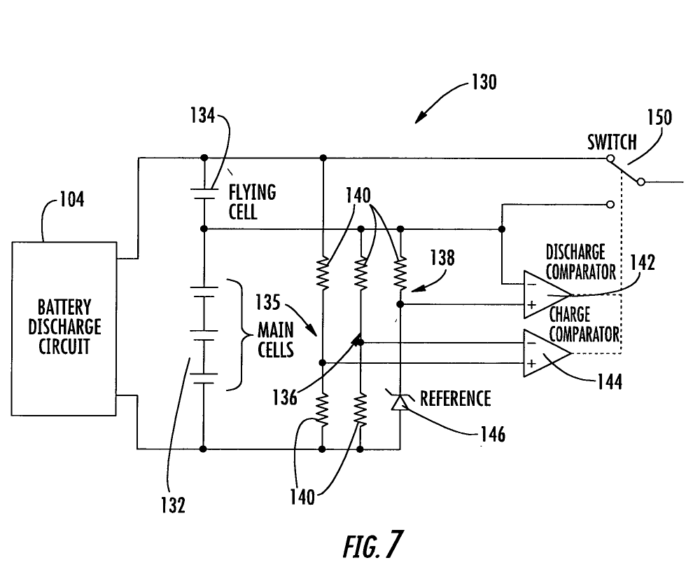

After description of the battery heater circuit, there follows a description of a system and method that automatically adjusts the heat setting for a battery. Two examples of a charge protection circuit using a field effect transistor are shown in FIGS. 5 and 6. An example of a flying cell circuit that could be used in accordance with one aspect of the present invention is shown in FIG. 7.

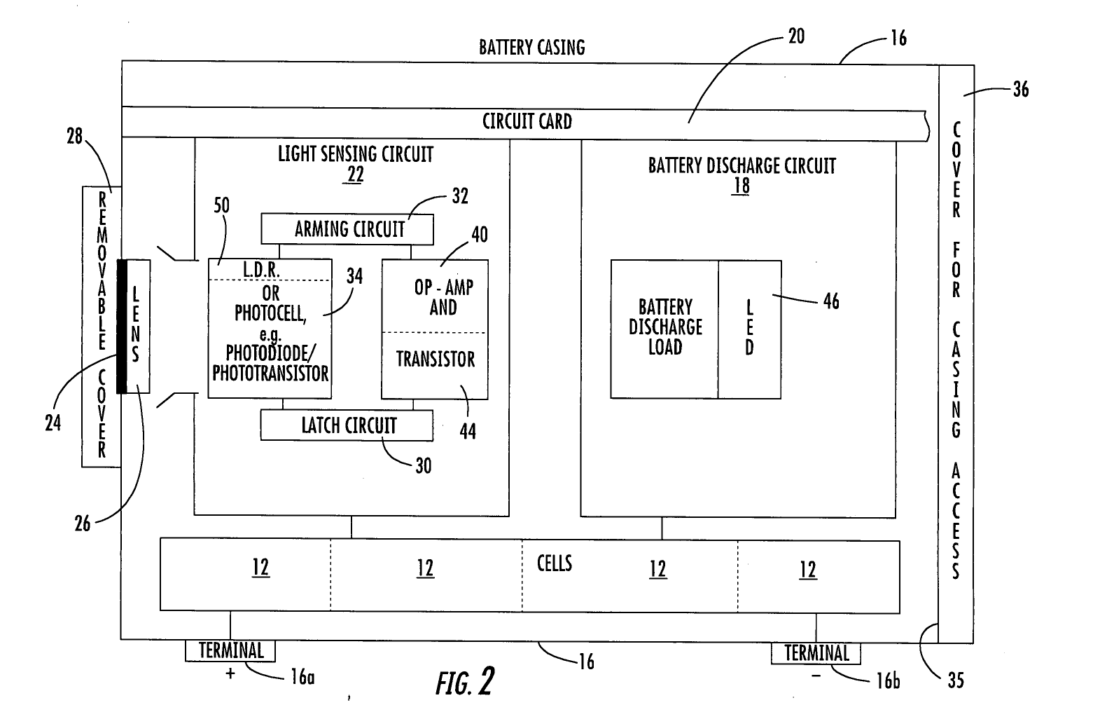

As shown in FIGS. 1 and 2, an apparatus for discharging a battery is shown, and includes a battery (a primary or rechargeable), for example, a lithium-ion battery as a non-limiting example, having a number of battery cells 12 contained within a battery casing 16. The battery casing 16 includes positive and negative terminals 16a, 16b, which interconnect the battery cells 12. A battery discharge circuit 18 is contained within the battery casing 16, such that when actuated, discharges the battery, and more particularly, the battery cells 12.

The battery discharge circuit 18 is formed on a circuit card 20 that is positioned in a medial portion of the battery casing 16, as a non-limiting example. A light sensing circuit 22 is operatively connected to the battery discharge circuit 18 and actuates the battery discharge circuit 18 after exposing to light the light sensing circuit. This circuit 22 also can be formed on the circuit card 20. The battery casing 16 preferably includes an opening 24 that forms a “window” for exposing the light sensing circuit 22 to light. This opening 24 preferably includes a lense 26, such as a transparent or substantially translucent lense, which can be formed from glass, plastic or other material known to those skilled in the art.

The lense 26 is positioned within the opening 24 and sealed to form a watertight barrier to moisture and water. A removable and opaque cover 28 is positioned over the opening 24 and lense 26 to block light from passing onto the light sensing circuit until the cover is removed. In one aspect, the opaque cover 28 could be a label or opaque, pull tab 28a (FIG. 1) that is adhesively secured to the battery casing and over the lense. Once the cover or tab 28, 28a is pulled from the casing, ambient light passes through the lense 26, through the opening 24, and onto the light sensing circuit 22 to actuate the battery discharge circuit 18.

As noted before, the lense 26 is preferably mounted in the opening 24 in a watertight seal to prevent water from seeping into the battery casing 16 and creating a fire hazard or explosion by contacting any lithium or other hazardous cells that have not been completely discharged. It should be understood that the watertight seal is provided by the lense 26 with the battery casing 16 and not by any pull tab, label or other cover 28 that is positioned over the opening.

Preferably the light sensing circuit 22 includes a latch circuit 30 that latches the battery discharge circuit 18 into an ON condition to maintain battery discharge even when the light sensing circuit is no longer exposed to light. A non-latching circuit could be used, but the light sensing circuit would require continual exposure of light to fully discharge the battery. Thus, with the latching circuit, the battery can be placed in a position such that light initially exposes the light sensing circuit 22. The light source can be removed while the battery maintains its discharge process.

An arming circuit 32 can be provided that arms the light sensing circuit 22 for operation after battery assembly. Thus, during the initial manufacturing process, the light sensing circuit 22 and battery discharge circuit 18 are disarmed and not operable. Any exposure of the light sensing circuit 22 to light will not activate the battery discharge circuit 18. At final assembly, however, the light sensing circuit, such as a light sensor, for example, a photocell 34 (FIG. 1), can be installed in the battery casing through a casing opening 35 and the opaque label placed over the lense 26 positioned in the opening 24 or “window.” When the circuit is armed, a casing cover or lid 36 can be attached and sealed to the battery casing. This arming circuit could be formed as a simple switch, a removable jumper connection, or printed circuit card, break-off tab 20a (FIG. 1), which once broken off, would allow the casing cover 36 to be placed thereon.

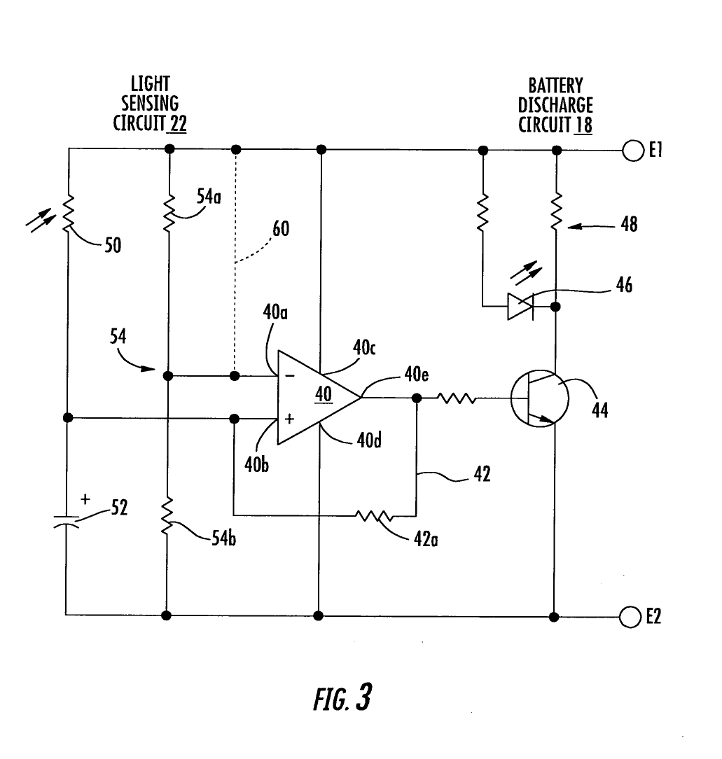

FIG. 3 shows an example of one type of circuit, as a non-limiting example, which could be used for the battery discharge apparatus. As illustrated, an operational amplifier 40 as a differentiator or similar circuit is operatively connected to the battery cell(s) with appropriate terminals labeled E1 and E2 having a potential difference there between for positive and negative values. The operational amplifier 40 includes the inverting input terminal 40a and the non-inverting input terminal 40b, appropriate voltage supply terminals 40c, 40d and an output terminal 40c. As illustrated, the operational amplifier 40 has a positive feedback loop circuit 42 and loopback resistor 42a that increases output and allows the operational amplifier to drive harder to saturation. The operational amplifier 40 switches state to turn on a transistor 44 acting as a switch, such as the illustrated NPN transistor, which connects to a light emitting diode 46 and resistor circuit having a resistor network 48 also forming a battery discharge load to allow discharge of the battery or battery cell. The light emitting diode 46 also emits light and acts as a visual indication of activation and could be used for battery discharge.

The light sensing circuit 22 includes a light dependent resistor 50 (as a non-limiting example) that can be formed such as by cadmium sulfide or other resistor material. The light dependent resistor 50 has a resistance value that decreases when exposed to light. The light dependent resistor 50 is operatively connected in series to a capacitor 52. Both the resistor 50 and capacitor are parallel with a voltage divider circuit 54 having two resistors 54a, 56b to provide a voltage divided input to the inverting input terminal 40a. The capacitor 52 could be designed with circuit components to provide some low pass or other filtering function. It also provides momentary disarm (when initially connecting to the battery). When transistor 44 is switched ON, in conjunction with the switched state of the operational amplifier, the discharge of cells remains even though the resistor 50 is no longer exposed to light. The light dependent resistor 50 and capacitor 52 also form a divider circuit that provides the input to the non-inverting input terminal 50b, which as noted before, receives the positive feedback from the output terminal 40c.

In this particular example, the arming circuit 32 is illustrated as a jumper line 60 and provides a current flow direct to the inverting input terminal 40a such that even when the operational amplifier 40, transistor 44, and overall battery discharge circuit 18 are connected to the battery cells, if the light dependent resistor 50 is exposed to light, and the resistance of the light dependent resistor drops, the jumper line 60 as illustrated provides a “short” to the inverting input terminal 40a such that the operational amplifier would not saturate and switch operating states. Thus, the operational amplifier would not bias the transistor ON to actuate the battery discharge circuit and operate the light emitting diode and thus allow discharge of the battery. This jumper line 60 could be formed as part of the circuit card 20 on the tab 20a, as shown in FIG. 1, such that before the battery casing cover 36 is placed on the battery casing, the breakable tab 20a formed on the circuit card 20 is broken to break the circuit line connection, as illustrated, and arm the circuit.

FIGS. 4-7 indicate other circuits that can be used in combination with the battery discharge circuit as described relative to FIGS. 1-3. It should be understood that the battery discharge circuit as described can be one type of battery discharge circuit and other discharge circuits can be used as suggested by those skilled in the art. It should also be understood that the circuits described relative to FIGS. 4-7 could operate within a battery alone or in combination with a battery discharge circuit. An example of a battery heater circuit in accordance with one example of the present invention is shown in FIG. 4. Two examples of a charge protection circuit using a field effect transistor are shown in FIGS. 5 and 6. An example of a flying cell circuit of the present invention is shown in FIG. 7. The reference numerals begin in the 100 series for the description relative to FIGS. 4-7.

FIG. 4 is a schematic circuit diagram of one example of a self-heating battery 100 and heating circuit 101 that can be used in accordance with one non-limiting example and shows a battery formed by one or more battery cells 102 operatively connected to a battery discharge apparatus or circuit 104, such as the battery discharge circuit described relative to FIGS. 1-3. It should be understood that other battery discharge circuits other than that described relative to FIGS. 1-3 could be used. The battery heating circuit 101 in one aspect overcomes the problem where a cell or battery has a minimum operating voltage for the “cut-off voltage” and, at lower temperatures, any powered equipment reaches its cut-off voltage prematurely while the cell or battery has remaining stored capacity.

The battery heating circuit 101 can typically be included within a battery casing 101a together with the battery discharge circuit 104 and any battery cells and includes a heating element 106, a load current sensor 108, and a temperature sensor 110 connected to a first operational amplifier operable as a comparator (operational amplifier) 112. The temperature sensor 110 can include a thermostat 110a operative therewith. The load current sensor 108 is connected to a second comparator circuit formed as a low current sensor operational amplifier 114a and high current operational amplifier 114b. Each operational amplifier 114a, 114b has its output connected to a respective switch 118a, 118b, each formed as a field effect transistor in this non-limiting illustrated embodiment. Although two operational amplifiers 114a, 114b are illustrated, it should be understood that one or more than the two operational amplifiers could be used in parallel with the first operational amplifier 112.

The temperature sensor 110 senses temperature when the cell or battery temperature is below the temperature where available capacity is limited, such as 10° C. above the minimum specified operating temperature of the cell. The temperature sensor 110 is operative with the first operational amplifier 112 to turn on the internal battery heater by providing power to the heating element 106 that is also operatively connected to battery cells 102 for power. This raises the temperature sufficiently such that the battery can deliver most of its rated capacity.

The load current sensor 108 is typically formed as a resistor, but other devices could be used. The sensor 108 is operative with the circuit to lock out the heating element 106 via the operational amplifiers 114a, 114b when the battery cell is not in use to prevent the heating element from discharging the battery when stored at cold temperatures. Operational amplifiers 114a, 114b are operable with the serially connected switches 116, 118a, 118b to lock out the heating element. As illustrated, operational amplifiers 112, 114a, 114b are connected to respective switches 116, 118a, 118b, each formed in this non-limiting example as a field effect transistor and operative as switches and connected to the output of the operational amplifiers 112, 114a, 114b.

The temperature sensor 110 is connected to both the inverting and non-inverting inputs of the operational amplifier 112. When the temperature is below the temperature where available capacity is limited, the output of the operational amplifier 112 causes the switch 116 to turn on the heating element 106. When the switch 116 is a field effect transistor (FET), it switches “ON” to provide power to the heating element.

The low current sensor and high current sensor operational amplifiers 114, 118a, 118b have their inverting and non-inverting inputs connected on either side of the load current sensor 108 formed in this example as a resistor to determine the voltage drop across the resistor. The outputs from at least one of the operational amplifiers 114a, 114b turns on a switch 118a, 118b, which in turn, would allow the heating element 102 to be switched “OFF” or “ON” as desired in conjunction with temperature sensor 110 and switch 116.

In another aspect of the invention, the battery could be required to deliver high energy, short duration discharge pulses. A load current sensor or other sensor could be operative to turn off the heating element when the discharge current is high. It could also ensure that available energy from the battery will be delivered to the load during periods of peak demand. The temperature sensor could be many different types of temperature sensors chosen by one skilled in the art.

Also, the battery discharge circuit 100 could include various sensors for locking out the heating element when the battery is not in use and turning off the heating element when a discharge current is high. It should be understood that the circuit of FIG. 4 could be modified for different types of battery cells and circuits.

In accordance with another aspect, the battery can sense the load demand and automatically set its internal heating to the optimum power or temperature for that load. A typical application might be for the battery when it is required to deliver high power pulses for shorter periods of time, or lower power pulses or power levels for longer periods of time depending on the specific application. In the case where the short duration, high power pulses are demanded of the battery, more heat is required or the battery cannot deliver the required power. Yet, if lower power levels are required, less heat is required. In this case, the use of more heat than necessary simply discharges the battery faster, wasting some of its stored energy.

In operation, when a load is applied, an internal current or load sensing circuit such as described above “wakes” the battery switch such that it operates in the high heat mode. An electronic timer circuit 119 is advantageously used such that if after some predetermined time period, such as ten minutes, a high power load or pulse has not been sensed by the load sensing circuit, the battery switches to the low heat mode. If at any time a high power pulse is detected, the battery remains in or switches back to the high heat mode for an additional 10 minutes.

In some applications the battery load may contain very short duration, high power pulses. In this condition, more heat may not be required. A second timer could be incorporated that would ignore power pulses that were less than some minimum predetermined time (such as one second). This would allow the battery to remain in the low heat mode even though some very short duration high energy load pulses were present.

The timer circuit 119 can include in one non-limiting example a long-term timer 119a and short-term timer 119b that are operative with the battery heater control circuitry as illustrated in the schematic circuit diagram of FIG. 4. In non-limiting examples, the long-term timer 119a is a 10-minute timer and the short-term timer 119b is a one-second timer and operative with the 10-minute timer. The 10-minute timer 119a is a one-shot timer that is started when a low power load is applied to the battery. When started, the timer's output (normally low) goes high enabling the battery heating circuitry. If the 10-minute timer 119a receives no reset from the one-second timer 119b, the 10-minute timer would time out at the end of ten seconds and its output would go low disabling the battery heating circuitry. If the battery load is disconnected and then reconnected, the above process will repeat. If the 10-minute timer does receive an input signal from the one-second timer, the 10-second timer is reset to zero and a 10-minute cycle begins anew with the heat still enabled.

In other aspects, the one-second timer 119b is started when a high power load is applied to the battery. If the high power load is present for one-second or greater, the output of the one-second timer (normally high) goes low and remains low until the high power load is removed. The low output of the one-second timer is used to reset the 10-minute timer. The purpose of the one-second timer is to prevent very short duration, high power pulses from enabling the battery heat.

Actual data from a typical example is set forth below in Table 1.

The low heat battery column shows how a battery configured for low heat mode performs for each discharge profile. The high heat battery column shows how the same battery re-configured for high heat mode performs for each discharge profile. The single underlining text indicates the high heat mode for the battery with automatic heat adjustment. The double underlining text indicates the low heat mode for the battery.

TABLE 1

| | | | | | Low | | |
|---|---|---|---|---|---|---|---|
| | | | | C.O. | Heat | High Heat | New |
| Test | Profile | Temp. | Rqmnt | Voltage | Battery | Battery | Battery |
| L2 | 1.8W/267S | −40 C. | 2.0 Hrs | 7.0 V | 0.8 Hrs | 4.6 Hrs | 4.6 Hrs |
| | 7.2W/30S | (−40 F.) | | 7.0 V | | | |
| | 26W/3S | | | 6.5 V | | | |
| | | | | Transient | | | |
| L9 | 26W/3S | −40 C. | 2.0 Hrs | 6.5 V | 1.7 Hrs | 2.25 Hrs | 2.25 Hrs |
| | 3.0W/ | (−40 F.) | | Transient | | | |
| | | | | 7.0 V | | | |
| L | 1.8W/267S | −29 C. | 4.0 Hrs | 7.0 V | 1.5 Hrs | 5.25 Hrs | 5.25 Hrs |
| | 7.2W/30S | (−20 F.) | | 7.0 V | | | |
| | 26W/3S | | | 6.5 V | | | |
| | | | | Transient | | | |
| L4 | 8.6W/2.1S | −29 C. | 7.0 Hrs | 6.5 V | 7.5 Hrs | 5.0 Hrs | 7.5 Hrs |
| | 3.2W/18.9S | (−20 F.) | | Transient | | | |
| | | | | 7.0 V | | | |
| L3 | 0.53W/48.48S | −20 C. | 28.5 Hrs | 7.0 V | 43.2 Hrs | 8.4 Hrs | 43.2 Hrs |
| | 2.56W/1.0S | (−4 F.) | | 6.5 V | | | |
| | 20.22W/0.52S | | | Transient | | | |
| | | | | 6.5 V | | | |
| | | | | Transient | | | |
| L5 | 4.7W/0.67S | 0 C. | 20 Hrs | 6.5 V | 21.3 Hrs | 12.7 Hrs | 21.3 Hrs |
| | 0.8W/1.33S | (32 F.) | | Transient | | | |
| | | | | 6.5 V | | | |
| | | | | Transient | | | |
| L6 | 9.0W/0.67S | 0 C. | 10 Hrs | 6.5 V | 11.1 Hrs | 8.6 Hrs | 11.1 Hrs |
| | 1.1W/1.33S | (32 F.) | | Transient | | | |
| | | | | 6.5 V | | | |
| | | | | Transient | | | |
| L8 | 8.2W/3.0S | 0 C. | 7.0 Hrs | 6.5 V | 11.7 Hrs | 8.2 Hrs | 11.7 Hrs |
| | 3.0W/27.0S | (32 F.) | | Transient | | | |
| | | | | 7.0 V | | | |

In one non-limiting example, the low heat mode is for a battery with a thermostat setting of −26 C. The high heat mode is for a battery with a thermostat setting of +15 C. Naturally, these values could vary substantially.

FIGS. 5 and 6 illustrate a charge protection circuit 120 that uses a field effect transistor (FET) 122 and an operational amplifier 124 to sense current through the FET by measuring a voltage drop. In an acquiescent state, the operational amplifier 124 senses no voltage across the FET (no current through it) and biases the FET off. The FET in both FIGS. 5 and 6 has an inherent body diode 126, as illustrated. Two different circuits as non-limiting examples are shown in FIGS. 5 and 6. Common elements in both circuit examples for FIGS. 5 and 6 use common reference numerals. Both FIGS. 5 and 6 show the battery discharge circuit 104 and battery cell(s) 102 in parallel with the battery discharge circuit 120. These circuits would typically be all contained within a battery casing. The operational amplifier 124 in both FIGS. 5 and 6 has an output connected to the input of the field effect transistor 122, which operates as a switch. In both examples of FIGS. 5 and 6, an inherent body diode 126 is connected to and in parallel to the source and drain of the field effect transistor 122, as illustrated.

In FIG. 5, the non-inverting input of the operational amplifier 124 is connected to the field effect transistor 122 at its output in a feedback loop configuration. The inverting input is operatively connected to the at least one battery cell 102 and field effect transistor 122, as illustrated.

In FIG. 6, the non-inverting and the inverting inputs of the operational amplifier 124 are connected to a resistor 128 connected to battery cell 102. The resistor is operative as a load sensor, thus allowing the operational amplifier 124 to measure the voltage drop developed across the resistor, which is connected to the battery cell(s) 102 (and discharge circuit 104) as illustrated. The circuits of FIGS. 5 and 6 also allow charge protection diode replacement.

FIG. 7 is a schematic circuit diagram of a flying cell battery circuit 130 that overcomes the problem where typical battery applications include two voltage limits that a battery must meet, as described above. In this type of arrangement, there is an open circuit voltage that must not be exceeded, or damage to a load could occur. There is also a minimum operating or cut-off voltage that must be maintained, or the load may not function. Because of internal resistance of the cells in a battery, the cell voltage drops significantly as a load is applied. This is aggravated at colder temperatures.

In some prior art proposals, the voltage requirements have been met by stacking as many series cells as possible without exceeding the open circuit voltage and adding as many parallel strings of cells as required to meet the cut-off voltage under the battery load and temperature operating requirements. This approach is effective and normally requires adding more cells than would normally be required. Besides adding weight and cost, this approach will not fit some physical space limitations.

An alternative approach has been the use of voltage regulation circuitry such as DC-to-DC converters. This approach is an improvement over adding parallel strings of cells, but it is costly, complex, and tends to be energy inefficient.

The flying cell circuit 130 of the present invention shown in FIG. 7 overcomes these shortcomings. It uses an extra tier of cells that is switched in when the battery voltage falls to near the minimum cut-off voltage and is switched out when the battery voltage rises near the open circuit voltage. As a result, the open circuit and cut-off voltage requirements may be met over a wide range of load currents and operating temperatures with a minimum number of cells, minimum complexity, and maximum energy efficiency.

For rechargeable batteries, additional circuitry can be used to ensure proper charging. The voltage of the flying cell is sensed and compared to the individual voltages of the standard or main cells. When the voltage of the individual main cells is lower than that of the flying cell (normally the case as the flying cell is in circuit only a portion of the total discharge time), the switching circuit connects the charger to the main cells. When the voltage of the individual main cells rises to equal that of the flying cell, the switching circuit connects the charger to the series combination of main cells and the flying cell.

As shown in FIG. 7, the main and fly cells 132, 134 are serially connected. The battery discharge circuit 104 is connected to the main cells 132 and a flying cell 134 in a parallel connection. The flying cell 134 could be a single or plurality of cells. First, second and third voltage divider circuits 135, 136, 138 include resistors 140 chosen for providing desired voltage drops. First and second voltage divider circuits 135, 136 are connected to a charge comparator 144 and the third voltage divider circuit 138 is connected to the discharge comparator 142. The first voltage divider circuit 135 connects to the non-inverting input and the second voltage divider circuit 136 connected to the inverting input of charge comparator. The third voltage divider circuit 138 is connected to the non-inverting input of the discharge comparator 142. The third voltage divider circuit 138 is operative with a reference 146, shown as a Zener diode in this one non-limiting example. The inverting input of the discharge comparator 142 is connected to a first terminal of a pole switch 150. The flying cell 134 and the first voltage divider circuit 134 is also connected. The output of the discharge and charge comparators 142, 144 are connected to the switch 150 as illustrated. The main cells 132 are connected to the other terminal of the switch 150, as are second and third voltage divider circuits 136, 138 and inverting input of operational amplifier 142.

The discharge comparator 142 and charge comparator 144 compare the battery voltage when it falls to near the minimum cut-off voltage and allows the extra tier of cells as a flying cell to be switched in when the battery voltage falls to this near minimum cut-off voltage that could be established as desired by those skilled in the art. It is switched out when the battery voltage rises near the open circuit voltage. The voltage on the flying cell is sensed and compared to the individual voltages of the standard main cells 132. When the voltage of the individual main cells 132 is lower than that of the flying cell 134, the switching circuit 150 connects the charger to the main cells. When the voltage of the individual main cells 132 rises to equal that of the flying cell, the switching circuit 150 connects the charger to the series combination of main cells and the flying cell.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A self-heating battery comprising:
a battery;
a heating element operatively connected to the battery for heating the battery;
a temperature sensor for determining the temperature of the battery;
a switch operatively connected to said heating element and temperature sensor and responsive to said temperature sensor for switching on the heating element and raising the temperature of the battery to allow the battery to deliver its rated capacity when a sensed temperature of the battery is below a temperature where available battery capacity is limited; and
a load sensing circuit operative with the switch for sensing load demand and activating low and high heat modes based on load demand.

2. A self-heating battery according to claim 1, wherein said load sensing circuit comprises a load sensing switch operative for activating battery heating based on sensed loads.

3. A self-heating battery according to claim 2, wherein said load sensing switch comprises a transistor.

4. A battery according to claim 1, wherein said load sensing circuit comprises a timer circuit such that after a predetermined time period a low heat mode is activated from a high heat mode.

5. A self-heating battery according to claim 4, wherein said timer circuit comprises a long-term timer, and a short-term timer that is non-responsive to any power pulses that are less than a predetermined time period.

6. A self-heating battery according to claim 4, wherein said timer circuit is operative such that after a predetermined time, if a high power load or pulse is not sensed, a low heat mode is activated.

7. A self-heating battery according to claim 1, wherein said load current sensing circuit comprises a load sensing device, and a comparator having inputs operatively connected to said load sensing device and an output operatively connected to said load sensing switch for determining low and high power loads or pulses and controlling the load sensing switch.

8. A self-heating battery according to claim 7, and further comprising low and high current load sensing switches and respective low and high current comparators operatively connected thereto for sensing low and high current conditions and activating low or high heat modes.

9. A self-heating battery according to claim 1, and further comprising a comparator having an output connected to said switch and inputs connected to said temperature sensor for comparing a temperature differential and turning the switch on and off and controlling operation of the heating element.

10. A self-heating battery according to claim 1, and further comprising a battery discharge circuit operative with the battery such that when actuated, discharges the battery.

11. A self-heating battery according to claim 10, wherein said battery discharge circuit further comprises a light sensing circuit operatively connected to the battery discharge circuit that actuates the battery discharge circuit after exposing to light the light sensing circuit.

12. A self-heating battery according to claim 1, wherein said heating element is powered from said battery.

13. A self-heating battery according to claim 1, and further comprising a housing enclosing the battery, heating element, temperature sensor and load sensing circuit.

14. A self-heating battery comprising:
a battery;
a heating element operatively connected to the battery for heating the battery;
a temperature sensor for determining the temperature of the battery;
a switch operatively connected to said heating element and temperature sensor and responsive to said temperature sensor for switching on the heating element and raising the temperature of the battery to allow the battery to deliver its rated capacity when a sensed temperature of the battery is below a temperature where available battery capacity is limited; and
a load sensing circuit operative with the switch for sensing load demand and setting the battery heating based on the load demand in a low or high power heat mode, and comprising a low current load sensing switch and high current load sensing switch operative with the switch connected to said heating element, a load current sensor, a low current comparator operatively connected to said low current load sensing switch and load current sensor, and a high current comparator operatively connected to said high current load sensing switch and load current sensor, such that said comparators determine low and high power loads, and a timer circuit operative with the low and high current load sensing switches and comparators such that after a predetermined time period, a low heat mode is activated based on sensed loads.

15. A self-heating battery according to claim 14, wherein said switch, low current load sensing switch and high current load sensing switch each comprises a transistor.

16. A self-heating battery according to claim 15, wherein said transistors each comprises a field effect transistor.

17. A self-heating battery according to claim 14, wherein said switch, low current load sensing switch and high current load sensing switch are serially connected to each other.

18. A self-heating battery according to claim 14, wherein said timer circuit comprises a long-term timer, and a short-term timer that is non-responsive to any power pulses that are less than a predetermined time period.

19. A self-heating battery according to claim 18, wherein said timer circuit is operative such that after a predetermined time, if a high power load or pulse is not sensed, a low heat mode is activated.

20. A self-heating battery according to claim 14, and further comprising a comparator having an output connected to said switch and inputs connected to said temperature sensor for comparing temperature differential and turning the switch on and off and controlling operation of the heating element.

21. A self-heating battery according to claim 14, and further comprising a battery discharge circuit operative with the battery that when actuated, discharges the battery.

22. A self-heating battery according to claim 21, wherein said battery discharge circuit further comprises a light sensing circuit operatively connected to the battery discharge circuit that actuates the battery discharge circuit after exposing to light the light sensing circuit.

23. A self-heating battery according to claim 14, wherein said heating element is powered from said battery.

24. A self-heating battery according to claim 14, and further comprising a housing enclosing the battery, heating element, temperature sensor and load sensing circuit.
